(19) United States
(12) Patent Application Publication
(10) Pub. No.: US 2026/0043918 A1
(43) Pub. Date: Feb. 12, 2026

(54) LOW-COST AND HIGH-RESOLUTION SIDE-SCAN SONAR IMAGING METHOD

(71) Applicant: Northwestern Polytechnical University, Xi'an (CN)

(72) Inventors: Xionghou LIU, Xi'an (CN); Jiahao FAN, Xi'an (CN); Yixin YANG, Xi'an (CN)

(73) Assignee: Northwestern Polytechnical University, Xi'an (CN)

(21) Appl. No.: 19/188,061

(22) Filed: Apr. 24, 2025

(30) Foreign Application Priority Data
Aug. 8, 2024 (CN) 202411081333.1

(51) Int. Cl. G01S 15/89; G01S 7/524; G01S 7/527

(52) U.S. Cl. CPC G01S 15/8902; G01S 7/524; G01S 7/5273

(57) ABSTRACT

In order to overcome the high-cost and low-resolution problems of the conventional side-scan sonar imaging method, a low-cost and high-resolution side-scan sonar imaging method is provided. The method includes: designing a low-cost array that can be used for side-scan sonar imaging; secondly, using the designed low-cost array to perform single-line high-resolution side-scan imaging; finally, continuously moving the side-scan sonar along a forward direction, continuously repeating a transmitting process and a receiving process in step 2 to obtain K single line imaging results, and then splicing the K single line imaging results to obtain a final side-scan sonar imaging result. Compared with the conventional side-scan sonar imaging method, by reasonably arranging the transmitting array and receiving array, the proposed method can significantly reduce the number of receiving array elements, that is, the side-scan sonar imaging resolution is improved while significantly reduce the cost.

### CROSS REFERENCE TO THE RELATED APPLICATIONS

This application is based upon and claims priority to Chinese Patent Application No. 202411081333.1, filed on Aug. 8, 2024, the entire contents of which are incorporated herein by reference.

### TECHNICAL FIELD

The present invention belongs to the field of sonar imaging method, and specifically relates to a low-cost and high-resolution side-scan sonar imaging method.

### BACKGROUND

Side-scan sonar is a device that uses the principle of echo measurement to draw seabed topography and detect underwater objects, which is widely used in underwater search and underwater investigation.

In the current working process, the side-scan sonar commonly uses a large aperture linear array to transmit pulse signals at the transmitting end, and a single transmitting beam is formed to illuminate the imaging scene; at the receiving end, a large aperture linear array is used to form a single receiving beam to process the echo, and the echo intensity is drawn in time sequence to obtain the side-scan imaging results of a single line; the side-scan sonar is moved to perform transmit and receive multiple times to obtain the imaging results of multiple lines; finally, the image of the whole imaging area can be obtained by splicing the results of multiple single line imaging. FIG. 1 shows the array diagram of the side-scan sonar composed of a 128-element transmitting linear array and a 128-element receiving linear array.

The angular resolution of the conventional side-scan sonar imaging method is determined by the aperture of the transmitting array and the receiving array. In order to obtain higher imaging angular resolution, the conventional method typically uses a larger aperture array to achieve this purpose, but the larger aperture array will increase the number of receiving array elements, leading to a dramatically increase in sensor costs and hardware costs. Therefore, how to obtain higher imaging angular resolution at low-cost requirements has become one of the problems in the development of side-scan sonar technology.

### SUMMARY

In order to overcome the high-cost and low-resolution problems of the conventional side-scan sonar imaging method, a low-cost and high-resolution side-scan sonar imaging method is proposed in the present invention. By reasonably arranging the transmitting array and receiving array, this method can significantly reduce the number of array elements to reduce the cost of array elements of side-scan sonar, and obtain higher angular resolution than the conventional side-scan sonar imaging method.

The technical scheme of the present invention is:
a low-cost and high-resolution side-scan sonar imaging method, the method includes the following steps:
step 1: designing a low-cost array that can be used for side-scan sonar imaging;
step 2: using the designed low-cost array to perform single-line high-resolution side-scan imaging;
step 3: continuously moving the side-scan sonar along a forward direction, continuously repeating a transmitting process and a receiving process in step 2 to obtain K single line imaging results, and then splicing the K single line imaging results to obtain a final side-scan sonar imaging result.

Further, in step 1:
defining a transmitting array as an M-element horizontal uniform linear array, and a receiving array as Nᵣ sub-arrays with smaller apertures, then element coordinates (xₜ, yₜ, zₜ) of the transmitting array are:

$$\begin{matrix}{x}_{t} = [ ( 0 : 1 : M - 1 ) - \frac{M - 1}{2} ] \times {d}_{t} \\ {y}_{t} = {[ \begin{matrix}0 & 0 & L & 0 & 0\end{matrix} ]}_{1 \times M} \\ {z}_{t} = {[ \begin{matrix}{d}_{tr} & {d}_{tr} & L & {d}_{tr} & {d}_{tr}\end{matrix} ]}_{1 \times M}\end{matrix}$$

the element coordinates (xᵣ, yᵣ, zᵣ) of the receiving array are:

$${\begin{matrix}\begin{matrix}{x}_{r} = \\ {y}_{r} = \\ {z}_{r} = \\ where ,\end{matrix} & [ \begin{matrix}( ( 0 : 1 : N - 1 ) - \frac{N - 1}{2} ) \times {d}_{r} - \frac{{N}_{r} - 1}{2} d \\ ( ( 0 : 1 : N - 1 ) - \frac{N - 1}{2} ) \times {d}_{r} - \frac{{N}_{r} - 3}{2} d \\ L \\ \text{?} \times {d}_{r} + \frac{{N}_{r} - 3}{2} d \\ \text{?} \times {d}_{r} + \frac{{N}_{r} - 1}{2} d\end{matrix} ]\end{matrix}}^{T}$$

$$\text{?} \text{indicates text missing or illegible when filed}$$

M is a number of transmitting array elements, and M≥32;
dₜ is an element spacing of the transmitting array, and c/(2fₜ)≤dₜ≤5c/(2fₜ), where c is an underwater sound velocity, and fₜ is a design frequency of the transmitting array;
N is a number of elements of each receiving sub-array, and 1≤N≤M/2;
dᵣ is an element spacing in each receiving sub-array, and c/(2fᵣ)≤dᵣ≤5c/(2fᵣ), where fᵣ is a design frequency of a single receiving sub-array;
Nᵣ is a number of sub-arrays of the receiving array;
d is an equivalent acoustic center spacing between Nᵣ sub-arrays, and a value of d is d=Mdₜ;
dₜᵣ is a spacing between a horizontal transmitting line array and a horizontal receiving line array in a same xOz plane in a z-axis direction, and c/(2fₜ)≤dₜᵣ≤5c/(2fₜ).

Further, the step 2 includes:
step 2-1: at a transmitting end, transmitting a pulse signal by using the M-element horizontal line array, and forming a single transmitting beam in a normal direction of the transmitting line array to illuminate a single line in an imaging area;
step 2-2: at a receiving end, receiving echoes by using the Nᵣ sub-arrays, and performing a summation process of the echoes on the Nᵣ sub-arrays to form a single receiving beam in the normal direction of the receiving line array;
step 2-3: calculating an intensity of the signal on the received beam according to the time sequence to obtain a single line imaging result.

Further,
in step 2-2: a two-dimensional side-scan sonar is taken as a model, the z-axis coordinates are not considered during an imaging process, and P far-field target modelings are defined as ideal scatterers and located at (xₚ,yₚ) (p=1, . . . , P), a receiving array acoustic center of the side-scan sonar is located at the xOy plane (x₀,y₀), an angle θₚ between a p^{th} target and a sonar normal is:

$${θ}_{p} = arctan ( \frac{{x}_{p} - {x}_{0}}{{y}_{p} - {y}_{0}} )$$

echo data X(t) collected by Nᵣ sub-arrays of the receiving array is expressed as:

$$x ( t ) = [ \begin{matrix}{\sum }_{p = 1}^{P} {a}_{r}^{1} ( {θ}_{p} ) {\sum }_{m = 1}^{M} {a}_{t}^{m} ( {θ}_{p} ) s ( {t}_{0} - \frac{\sqrt[2]{{( {x}_{p} - {x}_{0} )}^{2} + {( {y}_{p} - {y}_{0} )}^{2}}}{c} ) \\ ⋯ \\ {\sum }_{p = 1}^{P} {a}_{r}^{n} ( {θ}_{p} ) {\sum }_{m = 1}^{M} {a}_{t}^{m} ( {θ}_{p} ) s ( {t}_{0} - \frac{\sqrt[2]{{( {x}_{p} - {x}_{0} )}^{2} + {( {y}_{p} - {y}_{0} )}^{2}}}{c} ) \\ ⋯ \\ {\sum }_{p = 1}^{P} {a}_{r}^{{N}_{r} N} ( {θ}_{p} ) {\sum }_{m = 1}^{M} {a}_{t}^{m} ( {θ}_{p} ) s ( {t}_{0} - \frac{\sqrt[2]{{( {x}_{p} - {x}_{0} )}^{2} + {( {y}_{p} - {y}_{0} )}^{2}}}{c} )\end{matrix} ]$$

where,
s(t₀) is a synchronous pulse signal transmitted by the M-element horizontal line array;
t₀ is a time series of a transmitted pulse waveform;

$${a}_{t}^{m} ( {θ}_{p} ) = exp ( j 2 π {{f}_{0} [ {x}_{t} ( m ) , {y}_{t} ( m ) ] [ sin {θ}_{p} , cos {θ}_{p} ]}^{T} / c ) ( m = 1 , … , M ) ;$$

$${a}_{r}^{n} ( {θ}_{p} ) = exp ( j 2 π {{f}_{0} [ {x}_{r} ( m ) , {y}_{r} ( m ) ] [ sin {θ}_{p} , cos {θ}_{p} ]}^{T} / c ) ( n = 1 , … , {N}_{r} N ) ;$$

t is a time series of echoes collected by Nᵣ sub-arrays of the receiving array.

Optionally,
the conditions for the establishment of the X(t) include: it is defined that the sonar is in a relatively static state between an instantaneous moment of imaging and the target, an echo Doppler frequency shift is ignored; it is defined that there is no waveform distortion when an acoustic pulse propagates in a water medium, an interface reverberation and volume reverberation are ignored, and an influence of noise on the echo is ignored.

Further,
in step 2-3, a k^{th} single line imaging result b(k,t) is expressed as:

$$b ( k , t ) = \vert {[ \begin{matrix}1 & 1 & ⋯ & 1 & 1\end{matrix} ]}_{1 \times {N}_{r} N} x ( t ) \vert .$$

Further,
in step 3, a final side-scan sonar imaging result B(k,t) is expressed as:

$$B ( k , t ) = [ \begin{matrix}b ( 1 , t ) & ⋯ & b ( k , t ) & ⋯ & b ( K , t )\end{matrix} ] .$$

The beneficial effects of the present invention are:
1. a low-cost and high-resolution side-scan sonar imaging method is proposed in the present invention, which optimizes the receiving array of the conventional side-scan sonar, and uses the optimized side-scan sonar receiving array to achieve a higher resolution imaging effect.
2. The basic principle and implementation scheme of the present invention have been verified by computer numerical simulation, the results show that compared with the conventional side-scan sonar imaging method, the proposed method can significantly reduce the number of receiving array elements, that is, the side-scan sonar imaging resolution is improved withe significantly reducing the cost.

### BRIEF DESCRIPTION OF THE DRAWINGS

FIG. 1 is a schematic diagram of a conventional side-scan sonar array with 128-element transmitting and 128-element receiving;

FIG. 2 is a schematic diagram of a side-scan sonar array of M=128, Nᵣ=2, N=1 according to a method of the present invention;

FIG. 3 is a schematic diagram of a side-scan sonar array of M=128, Nᵣ=2, N=4 according to a method of the present invention;

FIG. 4 is a schematic diagram of a side-scan sonar array of M=64, Nᵣ=4, N=1 according to a method of the present invention;

FIG. 5 is a schematic diagram of a side-scan sonar array of M=64, Nᵣ=4, N=4 according to a method of the present invention;

FIG. 6 is a schematic diagram of a double scatterer target distribution according to an embodiment of the present invention;

FIG. 7 is a schematic diagram of a side-scan sonar imaging result of conventional 128-element transmitting 128-element receiving;

FIG. 8 is a schematic diagram of a side-scan sonar imaging result of M=128, Nᵣ=2, N=1 according to a method of the present invention;

FIG. 9 is a schematic diagram of a side-scan sonar imaging result of M=128, Nᵣ=2, N=4 according to a method of the present invention;

FIG. 10 is a schematic diagram of a side-scan sonar imaging result of M=64, Nᵣ=4, N=1 according to a method of the present invention;

FIG. 11 is a schematic diagram of a side-scan sonar imaging result of M=64, Nᵣ=4, N=4 according to a method of the present invention;

FIG. 12 is a slice diagram of conventional side-scan sonar imaging results of 128-element transmitting 128-element receiving;

FIG. 13 is a slice diagram of a side-scan sonar imaging result of M=128, Nᵣ=2, N=1 according to a method of the present invention;

FIG. 14 is a slice diagram of a side-scan sonar imaging result of M=128, Nᵣ=2, N=4 according to a method of the present invention;

FIG. 15 is a slice diagram of a side-scan sonar imaging result of M=64, Nᵣ=4, N=1 according to a method of the present invention;

FIG. 16 is a slice diagram of a side-scan sonar imaging result of M=64, Nᵣ=4, N=4 according to a method of the present invention.

FIG. 17 is a flowchart of a method according to the present invention.

### DETAILED DESCRIPTION OF THE EMBODIMENTS

In order to overcome the high-cost and low-resolution problems of the conventional side-scan sonar imaging method, a low-cost and high-resolution side-scan sonar imaging method is proposed in the present invention, by reasonably arranging the transmitting array and receiving array, this method can significantly reduce the number of array elements to reduce the cost of array elements of side-scan sonar, and obtain higher angular resolution than the conventional side-scan sonar imaging method.

The technical scheme adopted by the present invention to solve the existing problems can be divided into the following three steps:
step 1: a low-cost array that can be used for side-scan sonar imaging is designed;
a transmitting array is designed as an M-element horizontal uniform linear array (M≥32, M is a number of transmitting array elements), the element spacing is dₜ, and c/(2fₜ)≤dₜ≤5c/(2fₜ), where c is the underwater sound velocity, and fₜ is a design frequency of the transmitting array.

The receiving array is designed as Nᵣ sub-arrays with smaller apertures, and each sub-array is composed of an N-element horizontal uniform linear array (1≤N≤M/2, N is a number of elements of each receiving sub-array), an element spacing in each receiving sub-array is dᵣ, and c/(2fᵣ)≤dᵣ≤5c/(2fᵣ), where fᵣ is a design frequency of a single receiving sub-array. An equivalent acoustic center spacing between Nᵣ sub-arrays is d, and a value of d is d=Mdₜ, in order to reduce the number of elements to reduce the system cost, the number of sub-arrays Nᵣ is recommended to take 2, 3, 4, etc., and the number of elements N of each receiving sub-array can take a smaller value, such as 1, 2, 4, etc.

The horizontal transmitting linear array and the horizontal receiving linear array are located in the same xOz plane, the horizontal transmitting linear array and the horizontal receiving linear array are parallel to each other, and the spacing in the z-axis direction is dₜᵣ, and c/(2fₜ)≤dₜᵣ≤5c/(2fₜ), then array element coordinates (xₜ, yₜ, zₜ) of the transmitting array are:

$${x}_{t} = [ ( 0 : 1 : M - 1 ) - \frac{M - 1}{2} ] \times {d}_{t} \qquad ( 1 )$$

$${y}_{t} = {[ \begin{matrix}0 & 0 & L & 0 & 0\end{matrix} ]}_{1 \times M}$$

$${z}_{t} = {[ \begin{matrix}{d}_{tr} & {d}_{tr} & L & {d}_{tr} & {d}_{tr}\end{matrix} ]}_{1 \times M}$$

the element coordinates (xᵣ, yᵣ, zᵣ) of the receiving array are:

$${x}_{r} = {[ \begin{matrix}( ( 0 : 1 : N - 1 ) - \frac{N - 1}{2} ) \times {d}_{r} - \frac{{N}_{r} - 1}{2} d \\ ( ( 0 : 1 : N - 1 ) - \frac{N - 1}{2} ) \times {d}_{r} - \frac{{N}_{r} - 3}{2} d \\ L \\ ( ( 0 : 1 : N - 1 ) - \frac{N - 1}{2} ) \times {d}_{r} - \frac{{N}_{r} - 3}{2} d \\ ( ( 0 : 1 : N - 1 ) - \frac{N - 1}{2} ) \times {d}_{r} - \frac{{N}_{r} - 1}{2} d\end{matrix} ]}^{T} \qquad ( 2 )$$

$${y}_{r} = {[ \begin{matrix}0 & 0 & L & 0 & 0\end{matrix} ]}_{1 \times {N}_{r} N}$$

$${z}_{r} = {[ \begin{matrix}0 & 0 & L & 0 & 0\end{matrix} ]}_{1 \times {N}_{r} N}$$

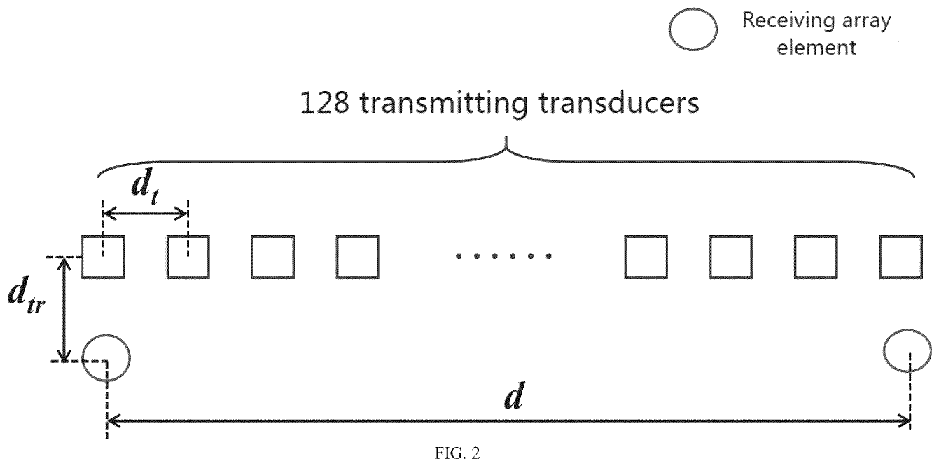

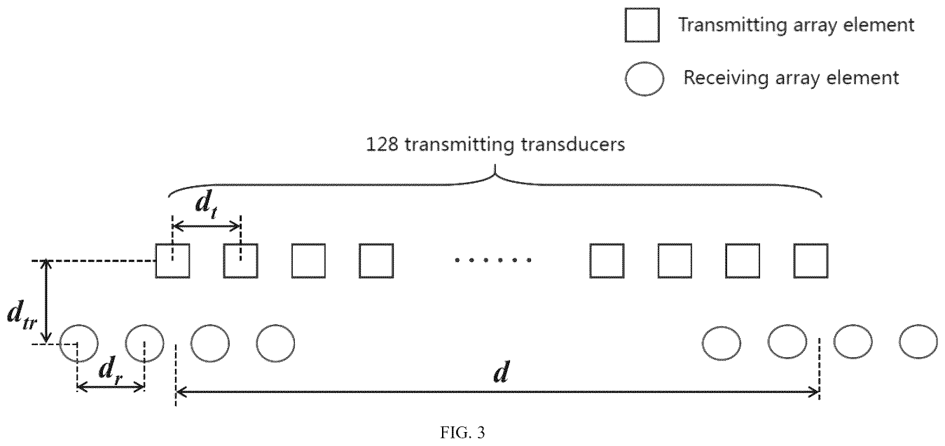

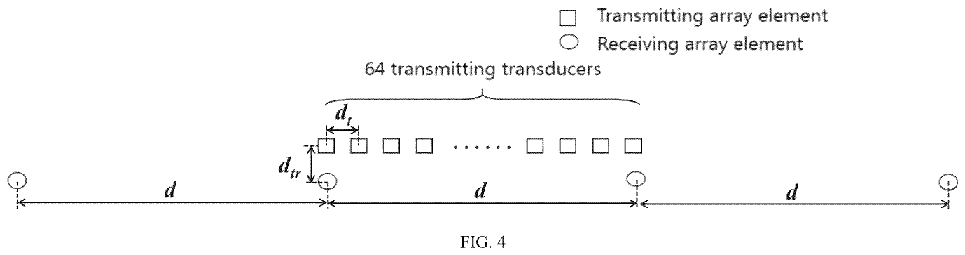

when the number of transmitting array elements is M=128, the number of receiving sub-arrays is Nᵣ=2, and the number of receiving array elements of a single sub-array is N=1 and 4, and when the number of transmitting array elements is M=64, the number of receiving sub-arrays is Nᵣ=4, and the number of receiving array elements of a single sub-array is N=1 and 4, the schematic diagrams of the corresponding side-scan sonar array are shown in FIG. 2, FIG. 3, FIG. 4, and FIG. 5, respectively.
Step 2: the designed low-cost array is used to perform single-line high-resolution side-scan imaging.
Step 2-1: at a transmitting end, a pulse signal s(t₀) is transmitted by using the M-element horizontal line array, t₀ is a time series of a transmitted pulse waveform, the M-element horizontal line array is synchronously transmitted to form a single narrow beam, the single narrow beam illuminates a single line in the imaging area.
Steps 2-2: after the pulse signal is reflected by the scatterer in the scene, at the receiving end, the Nᵣ sub-array of the receiving array is used to collect the echoes, a two-dimensional side-scan sonar is taken as a model, the z-axis coordinates are not considered during an imaging process, and P far-field target modelings are defined as ideal scatterers and located at (xₚ,yₚ) (p=1, . . . , P), a receiving array acoustic center of the side-scan sonar is located at the xOy plane (x₀,y₀), an angle θₚ between a p^{th} target and a sonar normal is:

$${θ}_{p} = arctan ( \frac{{x}_{p} - {x}_{0}}{{y}_{p} - {y}_{0}} ) \qquad ( 3 )$$

it is assumed that the sonar is in a relatively static state between an instantaneous moment of imaging and the target, an echo Doppler frequency shift is ignored; it is assumed that there is no waveform distortion when an acoustic pulse propagates in a water medium, an interface reverberation and volume reverberation are ignored, and an influence of noise on the echo is ignored, the echo data X(t) collected by Nᵣ sub-arrays of the receiving array is expressed as:

$$x ( t ) = [ \begin{matrix}{\sum }_{p = 1}^{P} {a}_{r}^{1} ( {θ}_{p} ) {\sum }_{m = 1}^{M} {a}_{t}^{m} ( {θ}_{p} ) s ( {t}_{0} - \frac{2 \sqrt{{( {x}_{p} - {x}_{0} )}^{2} + {( {y}_{p} - {y}_{0} )}^{2}}}{c} ) \\ ⋯ \\ {\sum }_{p = 1}^{P} {a}_{r}^{n} ( {θ}_{p} ) {\sum }_{m = 1}^{M} {a}_{t}^{m} ( {θ}_{p} ) s ( {t}_{0} - \frac{2 \sqrt{{( {x}_{p} - {x}_{0} )}^{2} + {( {y}_{p} - {y}_{0} )}^{2}}}{c} ) \\ ⋯ \\ {\sum }_{p = 1}^{P} {a}_{r}^{{N}_{r} N} ( {θ}_{p} ) {\sum }_{m = 1}^{M} {a}_{t}^{m} ( {θ}_{p} ) s ( {t}_{0} - \frac{2 \sqrt{{( {x}_{p} - {x}_{0} )}^{2} + {( {y}_{p} - {y}_{0} )}^{2}}}{c} )\end{matrix} ] \qquad ( 4 )$$

where,

$${a}_{t}^{m} ( {θ}_{p} ) = exp ( j 2 π {{f}_{0} [ {x}_{t} ( m ) , {y}_{t} ( m ) ] [ sin {θ}_{p} , cos {θ}_{p} ]}^{T} / c ) ( m = 1 , … , M ) ;$$

$${a}_{r}^{n} ( {θ}_{p} ) = exp ( j 2 π {{f}_{0} [ {x}_{r} ( n ) , {y}_{r} ( n ) ] [ sin {θ}_{p} , cos {θ}_{p} ]}^{T} / c ) ( n = 1 , … , {N}_{r} N ) ;$$

t is a time series of echo collected by Nᵣ sub-arrays of the receiving array;
the echo collected by all receiving array elements is summed, and a single receiving beam is formed in the normal direction of the receiving linear array.
step 2-3: an intensity of the signal on the received beam is calculated according to the time sequence to obtain a k^{th} single line imaging result b(k,t):

$$b ( k , t ) = \vert {[ \begin{matrix}1 & 1 & ⋯ & 1 & 1\end{matrix} ]}_{1 \times {N}_{r} N} x ( t ) \vert \qquad ( 5 )$$

step 3: the side-scan sonar is continuously moved along a forward direction, a transmitting process and a receiving process in step 2 are continuously repeated to obtain K single line imaging results, and then the K single line imaging results are spliced to obtain a final side-scan sonar imaging result B(k,t):

$$B ( k , t ) = [ \begin{matrix}b ( 1 , t ) & ⋯ & b ( k , t ) & ⋯ & b ( K , t )\end{matrix} ] \qquad ( 6 )$$

### Simulation Embodiment

The basic parameters of the simulation are set:
the real speed of sound wave propagation under water is set to be 1500 m/s, the side-scan sonar transmitting array is a horizontal uniform linear array, the array design frequency is 450 kHz, the spacing of transmitting array elements is set to a half-wavelength of 0.001667 m, the sampling frequency is 2 MHz, the transmitting signal is a continuous wave (CW) pulse signal, the transmitting signal frequency is 450 kHz and the signal pulse width is 0.05 ms.

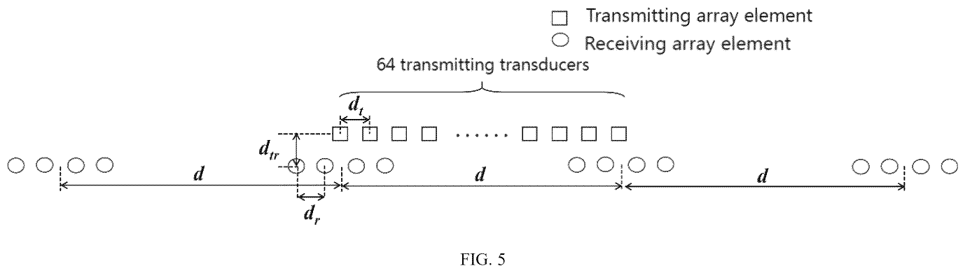

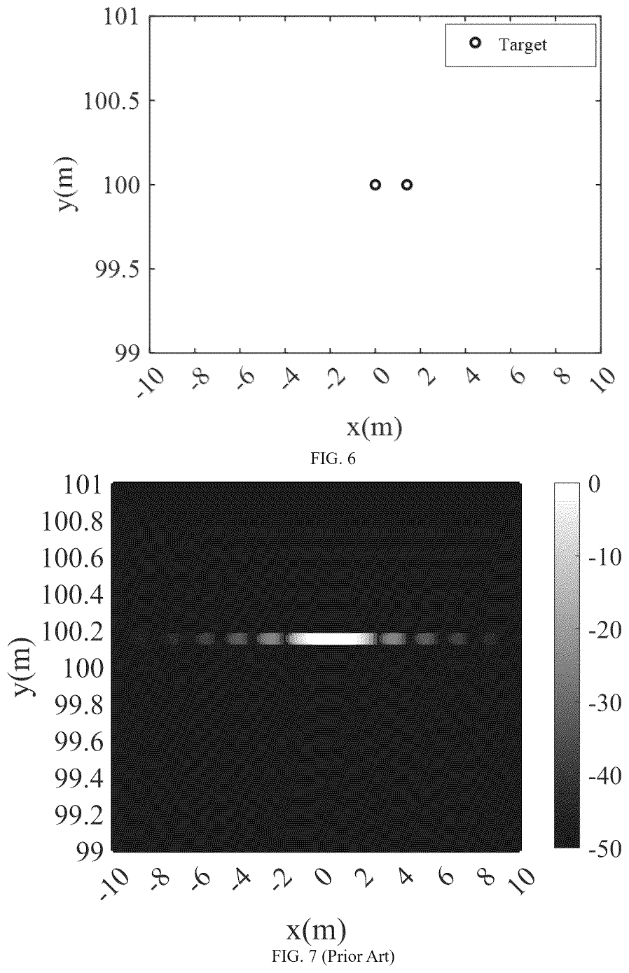

It is assumed that the side-scan sonar moves from (−10 m, 0 m) to (10 m, 0 m) along the positive direction of the x-axis to image the first and second quadrants of the coordinate axis, the two equal-intensity scatterer targets are located at (0 m, 100 m) and (1.4 m, 100 m), respectively, the distribution diagram is shown in FIG. 6.

The following is a simulation embodiment of the present invention, and the numerical simulation is carried out by computer simulation to test the effect of the method proposed in the present invention:
simulation 1: the conventional side-scan sonar imaging method is used for imaging.

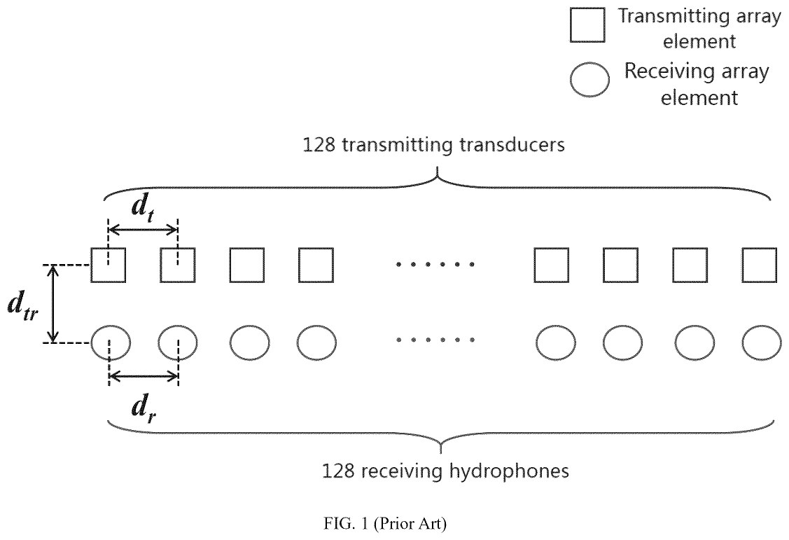

The number of transmitting array elements of side-scan sonar is 128, and the receiving array is a 128-element horizontal uniform linear array, the array design frequency is 450 kHz, and the array element spacing is set to a half-wavelength of 0.001667 m. The array diagram of the conventional side-scan sonar imaging method is shown in FIG. 1.
Simulation 2: the low-cost and high-resolution side-scan sonar imaging method of the present invention is used for imaging.

The number of transmitting array elements of side-scan sonar is 128, and the receiving array is two sub-arrays, the sub-arrays are horizontal uniform linear arrays, the number of elements of each sub-array is 1, the spacing of receiving hydrophone array elements in the sub-array is set to a half-wavelength of 0.001667 m, and the element spacing between the acoustic centers of sub-arrays is 0.213333 m, which is 128 times the spacing of transmitting array elements, the schematic diagram of the array is shown in FIG. 2.
Simulation 3: the low-cost and high-resolution side-scan sonar imaging method of the present invention is used for imaging.

The number of transmitting array elements of side-scan sonar is 128, and the receiving array is two sub-arrays, the sub-arrays are horizontal uniform linear arrays, the number of elements of each sub-array is 4, the spacing of receiving hydrophone array elements in the sub-array is set to a half-wavelength of 0.001667 m, and the element spacing between the acoustic centers of sub-arrays is 0.213333 m, which is 128 times the spacing of transmitting array elements, the schematic diagram of the array is shown in FIG. 3.
Simulation 4: the low-cost and high-resolution side-scan sonar imaging method of the present invention is used for imaging.

The number of transmitting array elements of side-scan sonar is 64, and the receiving array is four sub-arrays, the sub-arrays are horizontal uniform linear arrays, the number of elements of each sub-array is 1, the spacing of receiving hydrophone array elements in the sub-array is set to a half-wavelength of 0.001667 m, and the element spacing between the acoustic centers of sub-arrays is 0.213333 m, which is 64 times the spacing of transmitting array elements, the schematic diagram of the array is shown in FIG. 4.
Simulation 5: the low-cost and high-resolution side-scan sonar imaging method of the present invention is used for imaging.

The number of transmitting array elements of side-scan sonar is 64, and the receiving array is four sub-arrays, the sub-arrays are horizontal uniform linear arrays, the number of elements of each sub-array is 4, the spacing of receiving hydrophone array elements in the sub-array is set to a half-wavelength of 0.001667 m, and the element spacing between the acoustic centers of sub-arrays is 0.213333 m, which is 64 times the spacing of transmitting array elements, the schematic diagram of the array is shown in FIG. 5.

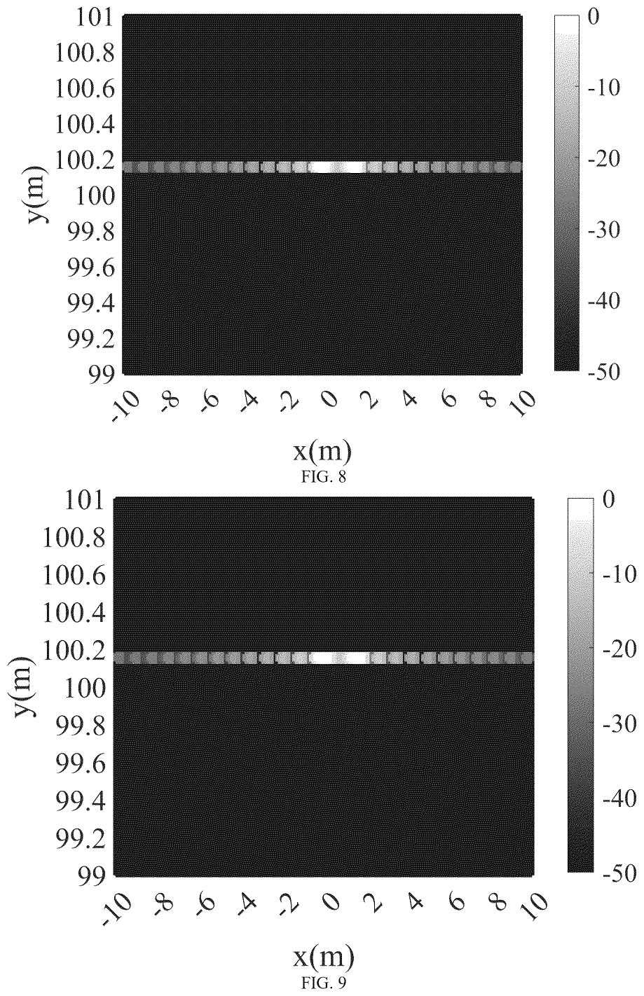

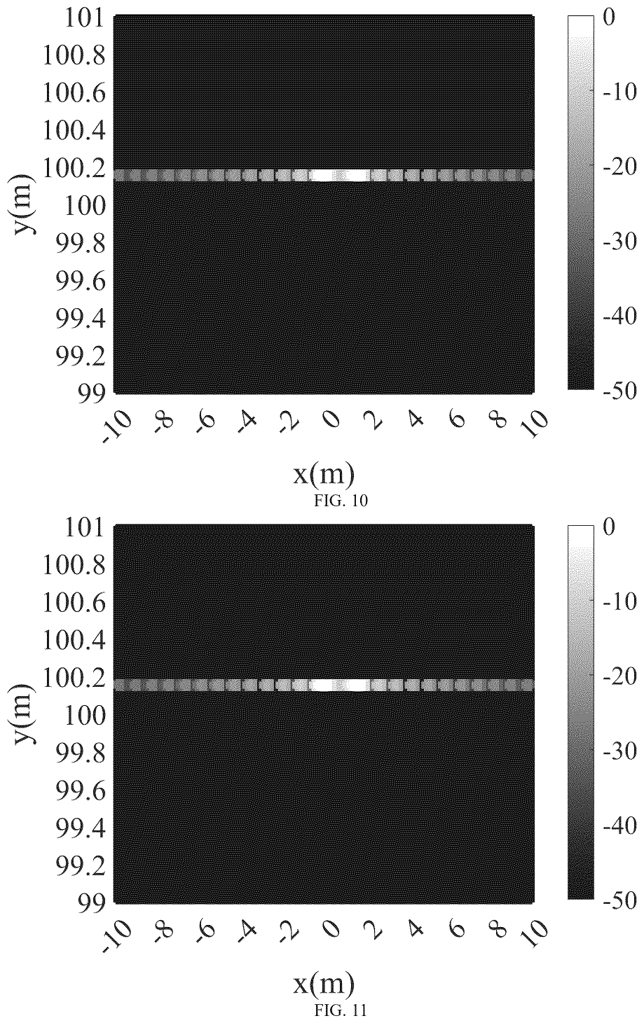

According to the imaging process of the conventional method, simulation 1 is imaged, and the two-dimensional imaging results of the conventional side-scan sonar imaging method are shown in FIG. 7, according to the method proposed in the present invention, the simulation 2, simulation 3, simulation 4 and simulation 5 are imaged respectively, and the imaging results of the low-cost and high-resolution side-scan sonar imaging method proposed in the present invention are shown in FIG. 8, FIG. 9, FIG. 10 and FIG. 11 respectively.

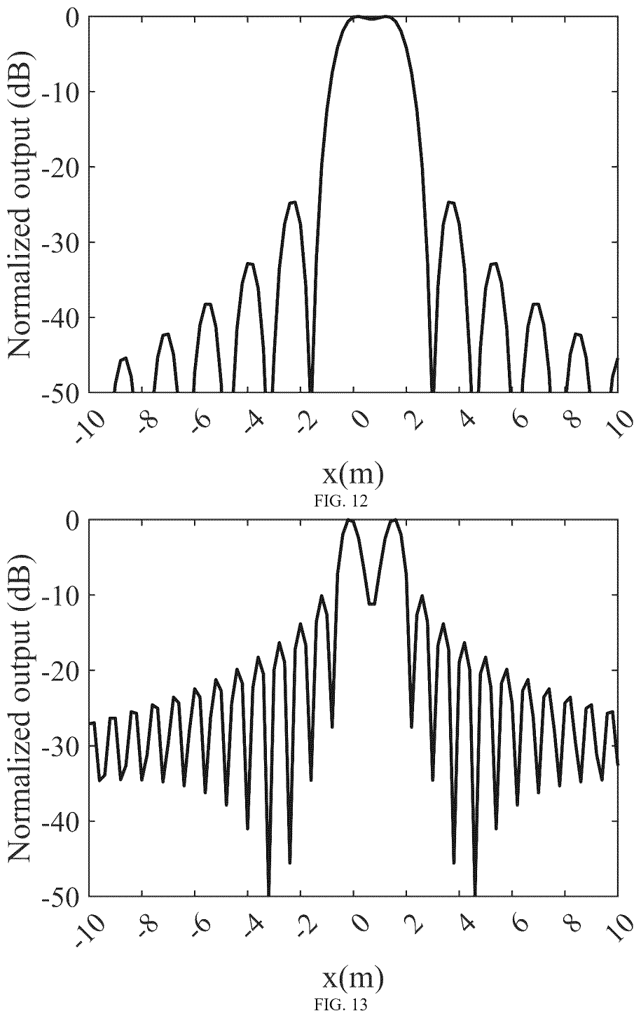

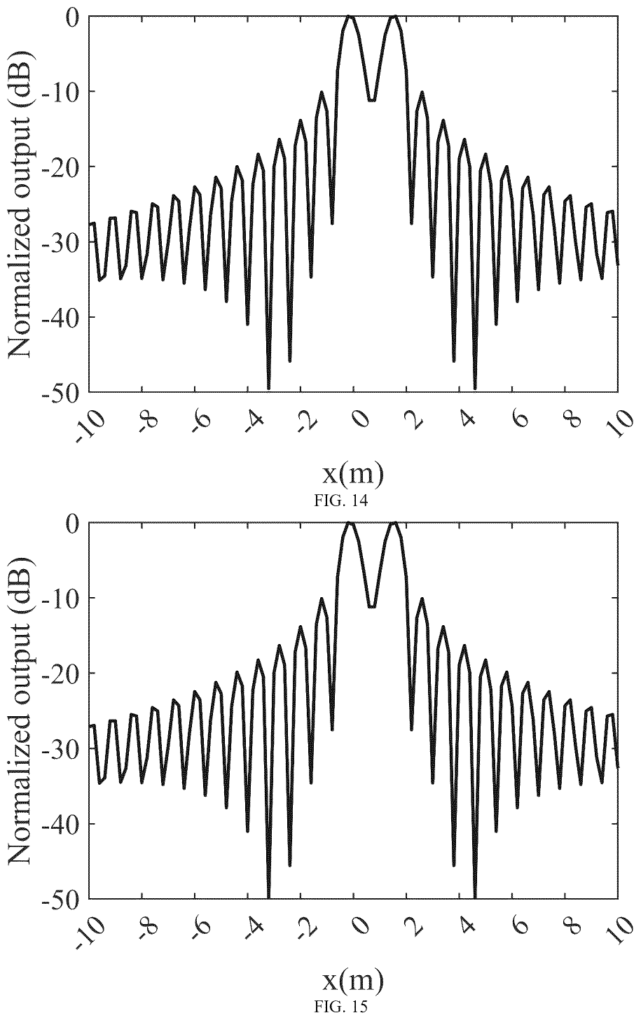

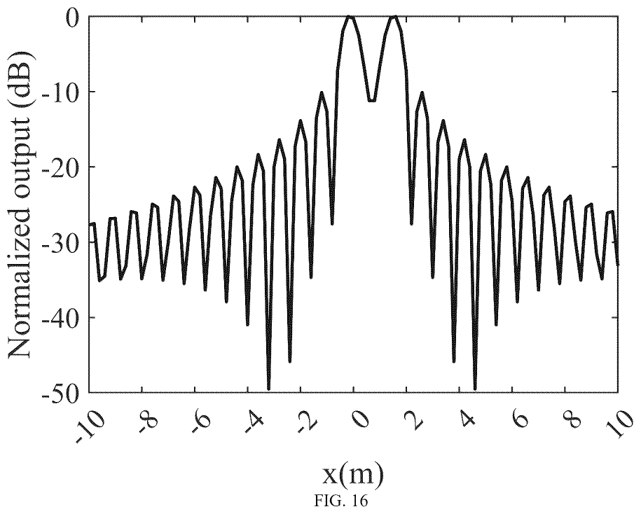

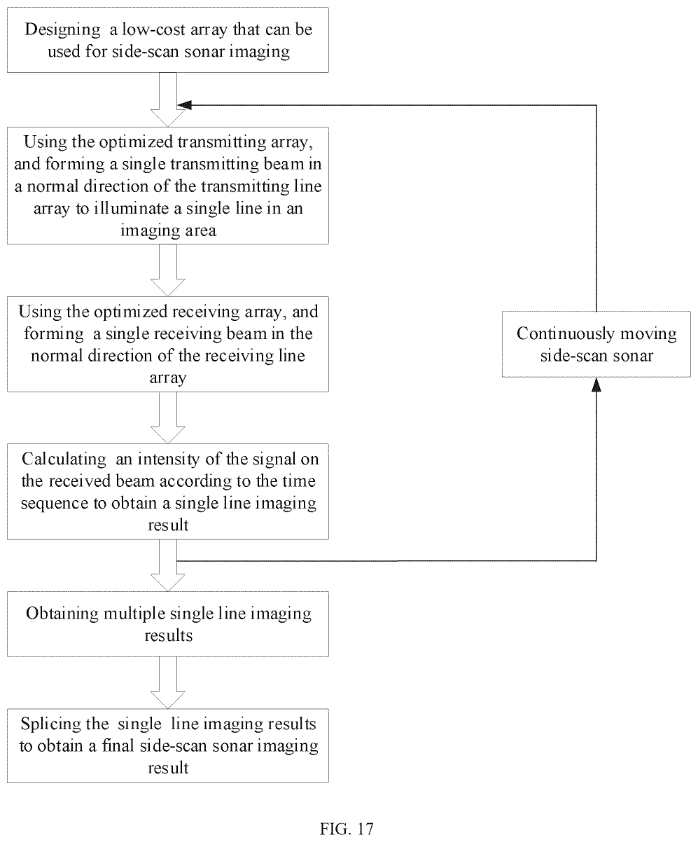

The imaging results of simulation 1, simulation 2, simulation 3, simulation 4, and simulation 5 are sliced along y=100 m, the slice images of simulation 1, simulation 2, simulation 3, simulation 4 and simulation 5 are shown in FIG. 12, FIG. 13, FIG. 14, FIG. 15 and FIG. 16 respectively.

Compared the imaging results of the conventional method with the imaging results of the proposed method, it can be seen that the conventional method cannot distinguish the two scatterers, and the low-cost and high-resolution method proposed in this present invention can clearly distinguish the two scatterers. According to FIG. 1 and FIG. 2, FIG. 3, FIG. 4, and FIG. 5, it can be seen that the present invention can optimize the number of transmitting array elements and the number of receiving array elements under the condition of proper design, so that the cost is significantly reduced. Therefore, compared with the conventional method, the proposed method can obtain higher resolution with fewer transmitting and receiving array elements and lower cost.

What is claimed is:

1. A low-cost and high-resolution side-scan sonar imaging method, comprising the following steps:
step 1: designing a low-cost array, wherein the low-cost array is used for side-scan sonar imaging;
step 2: using the low-cost array to perform single-line high-resolution side-scan imaging; and
step 3: continuously moving a side-scan sonar along a forward direction, continuously repeating a transmitting process and a receiving process in the step 2 to obtain K single line imaging results, and then splicing the K single line imaging results to obtain a final side-scan sonar imaging result.

2. The low-cost and high-resolution side-scan sonar imaging method according to claim 1, wherein in the step 1:
defining a transmitting array as an M-element horizontal uniform linear array, and a receiving array as Nᵣ sub-arrays with smaller apertures, wherein element coordinates (xₜ, yₜ, zₜ) of the transmitting array are:
$${x}_{t} = [ ( 0 : 1 : M - 1 ) - \frac{M - 1}{2} ] \times {d}_{t}$$
$${y}_{t} = {[ \begin{matrix}0 & 0 & L & 0 & 0\end{matrix} ]}_{1 \times M}$$
$${z}_{t} = {[ \begin{matrix}{d}_{tr} & {d}_{tr} & L & {d}_{tr} & {d}_{tr}\end{matrix} ]}_{1 \times M}$$
element coordinates (xᵣ, yᵣ, zᵣ) of the receiving array are:
$${x}_{r} = {[ \begin{matrix}( ( 0 : 1 : N - 1 ) - \frac{N - 1}{2} ) \times {d}_{r} - \frac{{N}_{r} - 1}{2} d \\ ( ( 0 : 1 : N - 1 ) - \frac{N - 1}{2} ) \times {d}_{r} - \frac{{N}_{r} - 3}{2} d \\ L \\ ( ( 0 : 1 : N - 1 ) - \frac{N - 1}{2} ) \times {d}_{r} - \frac{{N}_{r} - 3}{2} d \\ \text{?}\end{matrix} ]}^{T}$$
$${y}_{r} = {[ \begin{matrix}0 & 0 & L & 0 & 0\end{matrix} ]}_{1 \times {N}_{r} N}$$
$${z}_{r} = {[ \begin{matrix}0 & 0 & L & 0 & 0\end{matrix} ]}_{1 \times {N}_{r} N}$$
$$\text{?} \text{indicates text missing or illegible when filed}$$
wherein
M is a number of transmitting array elements, and M≥32;
dₜ is an element spacing of the transmitting array, and c/(2fₜ)≤dₜ≤5c/(2fₜ), wherein c is an underwater sound velocity, and fₜ is a design frequency of the transmitting array;
N is a number of elements of each receiving sub-array, and 1≤N≤M/2;
dᵣ is an element spacing in each receiving sub-array, and c/(2 fᵣ)≤dᵣ≤5c/(2f_{f}), wherein fᵣ is a design frequency of a single receiving sub-array;
Nᵣ is a number of sub-arrays of the receiving array;
d is an equivalent acoustic center spacing between the Nᵣ sub-arrays, and a value of d is d=Mdₜ; and
dₜᵣ is a spacing between a horizontal transmitting line array and a horizontal receiving line array in a same xOz plane in a z-axis direction, and c/(2fₜ)≤dₜᵣ≤5c/(2fₜ).

3. The low-cost and high-resolution side-scan sonar imaging method according to claim 1, wherein the step 2 comprises:
step 2-1: at a transmitting end, transmitting a pulse signal by using an M-element horizontal line array, and forming a single transmitting beam in a normal direction of a transmitting line array to illuminate a single line in an imaging area;
step 2-2: at a receiving end, receiving echoes by using Nᵣ sub-arrays, and performing a summation process of the echoes on the Nᵣ sub-arrays to form a single receiving beam in a normal direction of a receiving line array; and
step 2-3: calculating an intensity of a signal on the single receiving beam according to a time sequence to obtain a single line imaging result.

4. The low-cost and high-resolution side-scan sonar imaging method according to claim 3, wherein in the step 2-2:
a two-dimensional side-scan sonar is taken as a model, z-axis coordinates are not considered during an imaging process, P far-field target modelings are defined as ideal scatterers and located at (xₚ,yₚ) (p=1, . . . , P), a receiving array acoustic center of the two-dimensional side-scan sonar is located at an xOy plane (x₀,y₀), and an angle θₚ between a p^{th} target and a sonar normal is:
$${θ}_{p} = arctan ( \frac{{x}_{p} - {x}_{0}}{{y}_{p} - {y}_{0}} )$$
echo data X(t) collected by the Nᵣ sub-arrays of a receiving array is expressed as:
$$x ( t ) = [ \begin{matrix}{\sum }_{p = 1}^{P} {a}_{r}^{1} ( {θ}_{p} ) {\sum }_{m = 1}^{M} {a}_{t}^{m} ( {θ}_{p} ) s ( {t}_{0} - \frac{2 \sqrt{{( {x}_{p} - {x}_{0} )}^{2} + {( {y}_{p} - {y}_{0} )}^{2}}}{c} ) \\ ⋯ \\ {\sum }_{p = 1}^{P} {a}_{r}^{n} ( {θ}_{p} ) {\sum }_{m = 1}^{M} {a}_{t}^{m} ( {θ}_{p} ) s ( {t}_{0} - \frac{2 \sqrt{{( {x}_{p} - {x}_{0} )}^{2} + {( {y}_{p} - {y}_{0} )}^{2}}}{c} ) \\ ⋯ \\ {\sum }_{p = 1}^{P} {a}_{r}^{{N}_{r} N} ( {θ}_{p} ) {\sum }_{m = 1}^{M} {a}_{t}^{m} ( {θ}_{p} ) s ( {t}_{0} - \frac{2 \sqrt{{( {x}_{p} - {x}_{0} )}^{2} + {( {y}_{p} - {y}_{0} )}^{2}}}{c} )\end{matrix} ]$$
wherein
s(t₀) is a synchronous pulse signal transmitted by the M-element horizontal line array;
t₀ is a time series of a transmitted pulse waveform;
$${a}_{t}^{m} ( {θ}_{p} ) = exp ( j 2 π {{f}_{0} [ {x}_{t} ( m ) , {y}_{t} ( m ) ] [ sin {θ}_{p} , cos {θ}_{p} ]}^{T} / c ) ( m = 1 , … , M ) ;$$
$${a}_{r}^{n} ( {θ}_{p} ) = exp ( j 2 π {{f}_{0} [ {x}_{r} ( n ) , {y}_{r} ( n ) ] [ sin {θ}_{p} , cos {θ}_{p} ]}^{T} / c ) ( n = 1 , … , {N}_{r} N ) ;$$
and
t is a time series of the echoes collected by the Nᵣ sub-arrays of the receiving array.

5. The low-cost and high-resolution side-scan sonar imaging method according to claim 4, wherein conditions for an establishment of the echo data X(t) comprise:
the two-dimensional side-scan sonar is defined in a relatively static state between an instantaneous moment of imaging and a target, and an echo Doppler frequency shift is ignored; and
there is no waveform distortion when an acoustic pulse propagates in a water medium, an interface reverberation and a volume reverberation are ignored, and an influence of noise on the echoes is ignored.

6. The low-cost and high-resolution side-scan sonar imaging method according to claim 3, wherein in the step 2-3:
a k^{th} single line imaging result b(k,t) is expressed as:
$$b ( k , t ) = \vert {[ \begin{matrix}1 & 1 & ⋯ & 1 & 1\end{matrix} ]}_{1 \times {N}_{r} N} x ( t ) \vert .$$

7. The low-cost and high-resolution side-scan sonar imaging method according to claim 1, wherein in the step 3, the final side-scan sonar imaging result B(k,t) is expressed as:
$$B ( k , t ) = [ \begin{matrix}b ( 1 , t ) & ⋯ & b ( k , t ) & ⋯ & b ( K , t )\end{matrix} ] .$$
